(19) United States
(12) Patent Application Publication
(10) Pub. No.: US 2007/0044351 A1
(43) Pub. Date: Mar. 1, 2007

(54) Memorabilia cover

(76) Inventor: Pat Currie, Fort Worth, TX (US)

Correspondence Address: CHALKER FLORES, LLP, 2711 LBJ FRWY, Suite 1036, DALLAS, TX, 75234, US

(21) Appl. No.: 11/507,680

(22) Filed: Aug. 22, 2006

Related U.S. Application Data
(60) Provisional application No. 60/710,415, filed on Aug. 23, 2005.

(51) Int. Cl. G09F 11/00

(52) U.S. Cl. 40/1

(57) ABSTRACT

The present invention provides an apparatus, kit and method for covering memorabilia that include a first portion of the cover having a first cavity along an axis abutted to a second portion of the cover having a second cavity along the axis. The contacting of the first portion of the cover and second portion of the cover contact to form a cavity having the general dimensions of the bowling pin.

### CROSS-REFERENCE TO RELATED APPLICATIONS

This application claims priority to U.S. Provisional Application Ser. No. 60/710,415, filed Aug. 23, 2005, the contents of which is incorporated by reference herein in its entirety.

### TECHNICAL FIELD OF THE INVENTION

The present invention relates in general to the field of covers for memorabilia, and more particularly, to display covers for bowling pins.

### BACKGROUND OF THE INVENTION

Without limiting the scope of the invention, its background is described in connection with covers for memorabilia items, as an example. Proud memorabilia owners often attempt to preserve the item (e.g., bats balls, helmets, clubs, pins and so forth) in a variety of manners. Additionally, parents save bronzed baby shoes, photographs, baby hair, baby teeth, baby. clothes, toys, dolls, drawings, writings, audiotapes, films, birthday and sports souvenirs.

Attempts to preserve and display some items (e.g., bowling pins and baseball bats) have largely been unsuccessful since the item may be unsightly, fragile and generally difficult to present to a viewer. For example, one common location for birthday parties is the bowling alley, which provides a pleasant environment and enjoyable activates. At the conclusion of the party, many bowling alleys present the party members with an actual bowling pin. However, the bowling pin is often damaged, marred and has an unsightly appearance. Furthermore, the unsightly finish on the bowling pin prohibits the decorating or embellishing of the bowling pin and in the case of memorabilia alterations to the item would destroy the value.

In general, a bowling pin is manufactured from a blank of laminated wood into the original “bowling pin” shape and then synthetic resins are applied to the surface. In use, the bowling pin experiences a relatively high mechanical stress from the impact of bowling balls and other pins, resulting in damage to the surface and the subsurface of the bowling pin. Furthermore, the shape of the bowling pin causes the edge to be subjected to greater wear resulting in dents, splits, cracks, scuffs, chips and other blemishes. The impacts alter the once smooth surface of the bowling pin which in turn alters the play characteristics of the bowling pin. The bowling pins should have similar characteristics to provide consistent play. Therefore, when damage occurs the bowling pins must be repaired or discarded. As an alternative, many bowling alleys have turned to providing the bowling pins as gifts; however, the bowling pins are generally dented, cracked, marred, tarnished and generally unsightly.

The foregoing problems have been recognized for many years and while numerous solutions have been proposed, none of them adequately address all of the problems in a single device, e.g., unique shapes and unsightly appearance.

### SUMMARY OF THE INVENTION

The present inventor recognized a need for a memorabilia cover to encompass memorabilia items, while providing an attractive and protected cover with a decoratable surface.

The present inventor realized bowling pins that had actually been in use are difficult to present as gifts or display, due to the damaged, marred and unsightly appearance of the bowling pin. The condition of the bowling pin often dictates which bowling pins are given away as gifts and which are discarded. Furthermore, the unsightly finish prohibits the decorating or embellishing of the bowling pin. Therefore, the present invention provides a cover for bowling pins and other memorabilia.

Generally, the present invention provides a method for covering a memorabilia item by placing the memorabilia item into a first side cover having a first cavity along a longitudinal axis and abutting a second side cover having a second cavity along the longitudinal axis. The abutting of the first side cover and the second side cover form a cavity having the general dimensions of the memorabilia item.

The present invention also includes a memorabilia cover having a first portion of the cover with a first cavity along a longitudinal axis abutted to a second portion of the cover having a second cavity along the longitudinal axis. The first portion of the cover and the second portion of the cover form a cavity having the general dimensions of the memorabilia item.

More particularly, the present invention provides a bowling pin covering kit including a first portion of the cover having a first cavity along a longitudinal axis abutted to a second portion of the cover having a second cavity along the longitudinal axis. The aligning of the first portion of the cover and the second portion of the cover form a cavity having the general dimensions of the bowling pin.

### BRIEF DESCRIPTION OF THE DRAWINGS

For a more complete understanding of the features and advantages of the present invention, reference is now made to the detailed description of the invention along with the accompanying figures and in which:

FIG. 1 is a front view of a bowling pin cover in accordance with the present invention;

FIG. 2 is a side view of a bowling pin cover, in accordance with the present invention;

FIG. 3 is a front view of the bowling pin cover in accordance with the present invention;

FIG. 4 is a side view of a bat cover in accordance with the present invention;

FIG. 5 is a side view of a hat cover in accordance with the present invention; and

FIGS. 6A-6H are exemplar illustrations of profiles used in conjunction with the present invention.

### DETAILED DESCRIPTION OF THE INVENTION

While the making and using of various embodiments of the present invention are discussed in detail below, it should be appreciated that the present invention provides many applicable inventive concepts that can be embodied in a wide variety of specific contexts. The terminology used and specific embodiments discussed herein are merely illustrative of specific ways to make and use the invention and do not delimit the scope of the invention.

To facilitate the understanding of this invention, a number of terms are defined below. Terms defined herein have meanings as commonly understood by a person of ordinary skill in the areas relevant to the present invention. Terms such as “a”, “an” and “the” are not intended to refer to only a singular entity, but include the general class of which a specific example may be used for illustration. The terminology herein is used to describe specific embodiments of the invention, but their usage does not delimit the invention, except as outlined in the claims.

The present invention includes a cover that encompasses a memorabilia item (e.g., a bowling pin) to provide an attractive and decoratable surface for covering the memorabilia item. The present invention includes a memorabilia cover having a first portion of the cover with a first cavity along a longitudinal axis abutted to a second portion of the cover with a second cavity along the longitudinal axis. The aligning of the first portion of the cover and second portion of the cover form a cavity having the general dimensions of the memorabilia item it is designed to encompass. The memorabilia item may be a bowling pin, a bat, a hat, a baseball, a football, a soccer ball, a golf club, a hockey puck, a hockey stick, a boxing glove, a basketball, a bottle or combinations thereof.

In some instances, the first portion of the cover and second portion of the cover are interlocked and form a seal. The seal may be air tight and watertight. Alternatively, the seal or the cover itself may be breathable to allow air to circulate through the cover. Therefore, the seal may take many forms including a interlocking tongue and groove. configuration or mating edges. In addition the seal may be secured by glue, a resin, an epoxy, fused, welded or other method known to the skilled artisan. The one or more portions of the first portion of the cover, second portion of the cover or both portions may be transparent, opaque, florescent, painted, coated, stained or combinations thereof depending on the particular application. For example, a bowling pin cover may be made to display the winning pin for the national championship with a transparent plastic on one side of the bowling pin cover, to allow the unsightly damaged bowling pin to be seen, but the other side of the bowling pin cover is opaque and decorated with the. score and signatures.

The present invention also provides a method for covering a memorabilia item by placing the memorabilia item into a first side cover having a first cavity along a longitudinal axis and abutting a second side cover having a second cavity along a longitudinal axis. The aligning of the first side cover and the second side cover form a cavity having the general dimensions of the memorabilia item. Alternatively, the present invention provides a non-symmetrical 2-piece design. For example, the non symmetrical 2-piece design includes a first side cover with a first cavity along a horizontal axis and a corresponding second side cover having a second cavity. This configuration provides a basic top and bottom design. The first side cover and the second side cover contact to form the general shape of the memorabilia item.

The present invention also provides a bowling pin covering kit having a first portion of the cover having a first cavity along a longitudinal axis that is abutted to a second portion of the cover having a second cavity along the longitudinal axis. The first portion of the cover and second portion of the cover align to form a cavity having the general dimensions of a bowling pin.

The present invention includes a bowling pin cover having a first portion of the cover with a first cavity along a horizontal axis abutted to a second portion of the cover with a second cavity along the horizontal axis. The aligning and abutting of the first portion of the cover and a second portion of the cover form a cavity having the general dimensions of a bowling pin.

According to the present invention, a method for manufacturing a cover includes using a first mold having a first molding cavity of a larger dimension than the predetermined outside dimension of the item. The cover has a cavity to house the item. In instances where the item or cover is symmetric, one mold is used to form the two halves of the cover, e.g., balls, bats, pins, hats, pucks, bowling ball, baseball, baseball bat, sports shoe, baseball type hat, football helmet, baseball helmet, basketball, football, soccer ball, tennis racquet, tennis ball, golf ball, hockey puck, etc. In instances where the item is not symmetrical more than one mold is used to produce the cover, e.g., hats, pucks, baseball bat, sports shoe, baseball type hat, etc. The skilled artisan will recognize that the axis of symmetry may be selected which allows the item to be symmetrical.

According to the present invention, a method for manufacturing a bowling pin cover includes using a first mold having a first molding cavity of a larger dimension than the predetermined outside dimension of the bowling pin. A suitable material to for the cover is placed into the mold (e.g., a polymer), molded and allowed to cool. The process is repeated for the other pieces of the mold. When the molded pieces of the cover are placed together a cavity is formed having the shape of the item with an larger dimension than the predetermined outside dimension of the item. The cover may be of any thickness desired, e.g., 0.01 to 0.1, inches, 0.2, 0.3, 0.4, 0.5 and 0.6 to 1.0 inches.

The molds of the present invention may be of different configurations depending on the particular requirements of the application. In one example, two molds are used to create the cover for a bowling pin. A first mold and a second mold form a first side and a second side that mate to form the general shape of a bowling pin. The first side, the second side or both sides also include a bottom portion to enclose totally the bowling pin.

In another example, more than 2 molds are used to create a cover for an item. The skilled artisan will recognize the unlimited combinations of molds that may be used to create a cover for an item. One example uses three molds to form the cover. A first mold and a second mold form a first side cover and a second side cover that mate to form the general shape of the item. A third mold produces a bottom portion that mates to the first side cover and second side cover to enclose totally the item. In another embodiment, the cover includes three molds to produce a cover. A top mold and a bottom mold wherein the top mold corresponds to the top portion of the item and the bottom mold correspond to the bottom portion of the item. The top mold is further divided into a first mold to form a first side and a second mold to form a second side. Therefore, when the first side, the second side and the bottom mold are combined the cover encloses the item.

The molding process can be done by a variety of well known methods which have historically been applied to plastic materials, including high pressure extrusion, roller casting, passing the material through a pair of rollers; ram pressing, hot isostatic pressing, injection molding and other casting and forming methods. For example, the cover is made by forcing molten material to flow into the molding cavity of a mold. The material may be in part or entirely a synthetic resin, a plastic, a polymer, a composite, a fiber, a nanocomposite, a plaster or combinations thereof.

For example, the cover can be constructed using a press, which typically in includes a press unit, a control unit, a furnace and a mechanism to apply force, e.g., hydraulic press. Generally, a die is formed to the specific dimensions of the insert allowing for the individualized cover profiles for specific applications. Following modem practice, raw materials are blended, mixed and placed into contact with the die to form the cover by any one of several acceptable means, e.g., mechanical pressing, hand ramming hydraulic pressing or isostatic pressing. All these processes are currently in use by conventional processes. In addition, combinations of machining (e.g., molding, milling, pressing, stamping and/or casting) may be used to produce the cover. For example, a press or molded of a cover can produce the general shape of the item and the final shape can be produced through a conventional milling process.

Polymers that are suitable for use as the present invention include polyesters, polycarbonates, co-polymers of styrene and mixtures thereof. Examples of preferred matrix polymers are acrylonitrile-butadiene-styrene terpolymer (ABS); ABS modified polyvinylchloride; ABS-polycarbonate blends; acrylic resins and co-polymers: poly(methacrylate), poly(ethylmethacrylate), poly(methylmethacrylate), methylmethacrylate or ethylmethacrylate copolymers with other unsaturated monomers; casein; cellulosic polymers: ethyl cellulose, cellulose acetate, cellulose acetatebutyrate; ethyl vinyl acetate polymers and copolymers; poly(ethylene glycol); poly(vinylpyrrolidone); acetylated mono-, di-glycerides and tri-glycerides; poly(phosphazene); chlorinated natural rubber; polybutadiene; polyurethane; vinylidene chloride polymers and copolymers; styrene-butadiene copolymers; styrene-acrylic copolymers; alkylvinylether polymers and copolymers; cellulose acetate phthalates; epoxies; ethylene copolymers: ethylene-vinyl acetate-methacrylic acid, ethylene-acrylic acid copolymers; methylpentene polymers; modified phenylene oxides; polyamides; melamine formaldehydes; phenolformaldehydes; phenolic resins; poly(orthoesters); poly(cyanoacrylates); polydioxanone; polycarbonates; polyesters; polystyrene; polystyrene copolymers: poly(styrene-co maleic anhydride); urea-formaldehyde; urethanes; vinyl resins: vinyl chloride-vinyl acetate copolymers, polyvinyl chloride and mixtures of two or more of these.

Furthermore, materials used in the present invention also include thermoplastics materials like acetal (e.g., produced by the polymerization formaldehyde [CH₂O] into both homopolymer and copolymer); acrylics; acrylic esters [CH₂CHCOOR]; methacrylic esters [CH₂C(CH₃)COOR]; methyl, ethyl, butyl, or 2-ethylhexyl acrylates; Acrylonitrile-Butadiene-Styrene (ABS) (e.g., styrene [C₆H₅CHCH₂] and varying amounts of acrylonitrile [CH₂CHCN] and butadiene [CH₂CHCHCH₂]); Alkyds, (e.g., unsaturated polyester resins produced by reacting an organic alcohol with an organic acid); styrene [C₆H₅CHCH₂]; diallyl phthalate [C₆H₄(COOCH₂CHCH₂)₂]; diacetone acrylamide [CH₃COCH₂C(CH₃)₂CHCHCONH₂]; vinyl toluene [CH₂CHC₆H₄CH₂]; cellulosics chemical modification of cellulose resins (e.g., (C₆H₁₀O₅)n); cellulose xanthate [ROCSSH]; cellulose acetate acetic acid ester [CH₃COOC₂H₅] of cellulose; cellulose acetate butyrate a mixed ester produced by treating fibrous cellulose with butyric acid [CH₃CH₂CH₂COOH], butyric anhydride [(CH₃CH₂CH₂CO)₂O], acetic acid [CH₃COOH] and acetic anhydride [(CH₃CO)₂O] in the presence of sulfuric acid [H₂SO₄]; cellulose propionate; coumarone-indene; diallyl phthalate (DAP) (e.g., monomer [C₆H₄(COOCH₂CHCH₂)₂] is used as a cross-linking agent in unsaturated polyester resins); epoxy containing one or more reactive epoxide or oxirane groups; fluoropolymer (e.g., fluoropolymers are: FEP (fluorinated ethylene-propylene) from tetrafluoroethylene [C₂F₄] and hexa-fluoropropylene [C₃F₆]; PTFE (polytetra fluoroethylene) from the polymerization of tetrafluoroethylene and ethylene [C₂H₄]; PFA (perfluoroalkoxy) from tetrafluoroethylene and perfluoropropyl vinyl ether [C₃H₇C₄OF₅]; PCTFE (polychlorotrifluoro-ethylene) from chlorotrifluoro-ethylene monomer [C₂F₃CI]; CTFE-VDF (polychlorotrifluoroethylenevinylidene fluoride) from chlorotrifluoroethylene and vinylidene fluoride [C₂H₂F₂]; E-CTFE (polyethylenechlorotrifluoroethylene) from chlorotrifluoroethylene and ethylene; PVDF (polyvinylidene fluoride) from vinylidene fluoride monomer; and PVF (polyvinyl fluoride) from vinyl fluoride monomer [C₂H₃F]); melamine-formaldehyde; nitrile resins; nylon (e.g., nylon 4 (polypyrrolidone)-a polymer of 2-pyrrolidone [CH₂CH₂CH₂C(O)NH]; nylon 6 (polycaprolactam)-made by the polycondensation of caprolactam [CH₂(CH₂)₄NHCO]; nylon 6/6-made by condensing hexamethylenediamine [H₂N(CH₂)₆NH₂] with adipic acid [COOH(CH₂)₄COOH]; nylon 6/10-made by condensing hexamethylenediamine with sebacic acid[COOH(CH₂)₈COOH]; nylon 6/12-made from hexamethylenediamine and a 12-carbon dibasic acid; nylon 11-produced by polycondensation of the monomer 11-amino-undecanoic acid [NH₂CH₂(CH₂)₉COOH]; nylon 12-made by the polymerization of laurolactam [CH₂(CH₂]₁₀CO)or cyclododecalactam, with 11 methylene units between the linking —NH—CO—groups in the polymer chain); petroleum resins; phenolic; polyamide-imide; polyarylates; polybutylene; polycarbonate; polyethylene; polyimides; polyphenylene oxide; polyphenylene sulfide; polypropylene; polystyrene; polyurethanes; polyvinyl acetate (PVAC) and other vinyls; polyvinyl chloride; styrene acrylonitrile; styrene butadiene latexes; styrene copolymers; sulfone polymers; polyethylene terephthalate (PET); unsaturated polyester; and combinations thereof.

In another example, a cover is produced by machining (e.g., molding, milling, pressing, stamping and/or casting) material to a shape slightly larger than the shape of the item it is to cover. For example, a cover is milled from a wooden blank to house a bowling pin. The cover may then be stained and varnished to provide an attractive cover for the bowling pin. The materials of the present invention may be either as a whole or in part a metal, an alloy, a ceramic, a composite, a nonmetal, a wood, a polymer, a composite, a resist, a resin, a plastic or combinations thereof. The metals include gold, silver, platinum, copper, aluminum, tungsten, titanium, tantalum, molybdenum, chromium, nickel, alloys thereof or combinations thereof. The metal compound may be titanium nitride, titanium tungsten, tantalum nitride, tungsten nitride, molybdenum nitride or the like.

Coatings may be applied to the surface of the cover in the form of a solid, liquid, gel and mixed with numerous additives to create the specific characteristics for the individual application. In addition, the coating may be applied by brush, spray gun, dipping, aerosol, depositing and combinations thereof. In one instance, a coating may be applied that bond between the coating. Furthermore, coatings may be added to the surface that aid in decorating the surface, e.g., dry swipe materials, chalkboard materials and the like.

The present invention relates to a bowling pin, which includes indoor bowling, ten pin bowling, nine pin bowling, five pin bowling, duck pin bowling; however other items may be covered by the present invention. For example, present invention may also be used to cover bats, which can receive damage during use and in-turn may be unsightly.

The general shape and size of a bowling pin is defined by the American Bowling Congress and other regulatory establishments. Therefore, the covers will have a specific size and shape, e.g., about 15.25 inches high and about 5.0 inches wide. Similarly, most sporting regulations dictate the size and shape of the equipment used in that sport, e.g., bat sizes of about 30, 32, 36 inches; bowling balls of between about 8.5 and about 8.6 inches outside diameter, baseballs, softballs, helmets, etc.

In addition to covering unsightly areas, the cover of the present invention provides areas for decoration, e.g., ticket stubs, baseball cards, coins, signatures or other memorabilia. Allowing other memorabilia to be displayed with the item itself. For example, a baseball bat cover is designed to house the baseball bat itself and provide a surface for the signature of the team members. Additionally, the cover has a region designed to house the ticket stub. In addition, the cover provides a protective barrier between the item and the environment, which is especially applicable for transport of the item and allows the handling of the item with out worry of damage. Heat shrink or stretch type film wrapping is also employed with some applications to surround the cover. In some instances the cover is fitted to accept jewels, handles, decorative items, e.g., letters, flowers and the like.

Generally, the present invention includes a memorabilia cover that has a first portion of the cover and a second portion of the cover. The first portion of the cover and the second portion of the cover have the general shape of the memorabilia item to be incased. The first portion of the cover and the second portion of the cover are abutted at the parameter to form a cavity in the general shape of the memorabilia item. The parameters may have a variety of mating profiles, e.g., the profiles may be slots and notches, holes and pegs, curves and curves, hole and peg or a combination thereof. The memorabilia cover may be constructed from a variety of materials including metals, plastics wood, polymers, plasters, composites, ceramics, granite, stone, wicker, bamboo, clay, brick and mixtures and combinations thereof Furthermore, the memorabilia cover may be stained, engraved, painted, varnished, etched, coated, glazed, fused, impregnated and combinations thereof.

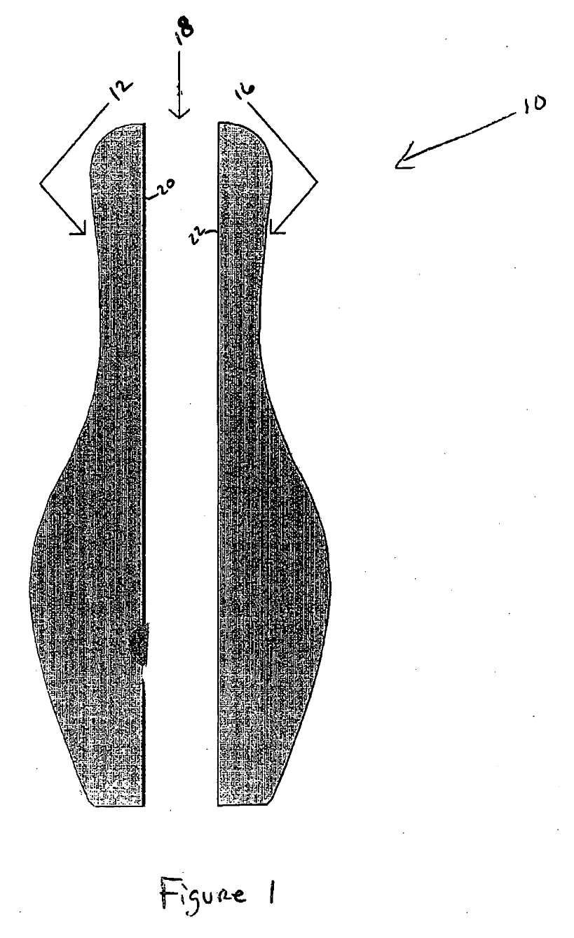

With reference to FIG. 1, a front view of a bowling pin cover 10, in accordance with the present invention is shown and includes a first portion of the cover 12 and a second portion of the cover 16. The first portion of the cover 12 and the second portion of the cover 16 have the general shape of a bowling pin with a region of greater diameter in the lower portion of the first portion of the cover 12 and the second portion of the cover 16. The bowling pin cover 10 has an upper portion, which is of a lesser diameter with a rounded shape 18. The first portion of the cover 12 and the second portion of the cover 16 are abutted at the first cover parameter 20 and the second cover parameter 22 to form a cavity along the longitudinal axis in the general shape of a bowling pin.

The first cover parameter 20 and the second cover parameter 22 may have a variety of profiles to produce a junction. The first cover parameter 20 has a notch (not shown) and the second cover parameter 22 has a groove (not shown), wherein the notch (not shown) and groove (not shown) fit together to secure the first portion of the cover 12 and the second portion of the cover 16. The first cover parameter 20 may have a variety of profiles, which mate to the corresponding counter profile on the second cover parameter 22, e.g., the profiles may be slots and notches, holes and pegs, curves and curves, whole and peg or a combination thereof. In addition, the profiles may have structures that secure the first portion of the cover 12 and the second portion of the cover 16, e.g., pins, rivets or dowels. In some instances, the profiles (not shown) overlap to secure the first portion of the cover 12 and the second portion of the cover 16. Alternatively, the first cover parameter 20 and the second cover parameter 22 may be flat and secured with a solvent, epoxy, adhesive, molded together, melted together, fused together or combination thereof.

The bowling pin cover 10 may be constructed from a variety of materials including metals, plastics wood, polymers, plasters, composites, ceramics, granite, stone, wicker, bamboo, clay, brick and mixtures and combinations thereof. In addition, the bowling pin cover 10 may be constructed of different materials in different regions. The first portion of the cover 12 and the second portion of the cover 16 may be made of similar materials.

Furthermore, the bowling pin cover 10 may be stained, engraved, painted, varnished, etched, coated, glazed, fused, impregnated and combinations thereof. In particular, the bowling pin cover 10 may be coated with a substance to allow the decoration of the bowling pin cover 10, e.g., decoupaged, painted and signed.

For example, birthday parties held at bowling alleys often receive damaged bowling pins (not shown) as gifts. The bowling pins are often dented, chipped, cracked and generally unsightly, thus limiting thus uses. The present invention provides a bowling pin cover. The bowling pin (not shown) is placed into the bowling pin cover 10 and the first portion of the cover 12 and second portion of the cover 16 are abutted at the first cover parameter 20 and second cover parameter 22 to secure the bowling pin cover 10. The bowling pin cover 10 is then decorated, signed and colored to immortalize the party and the guests.

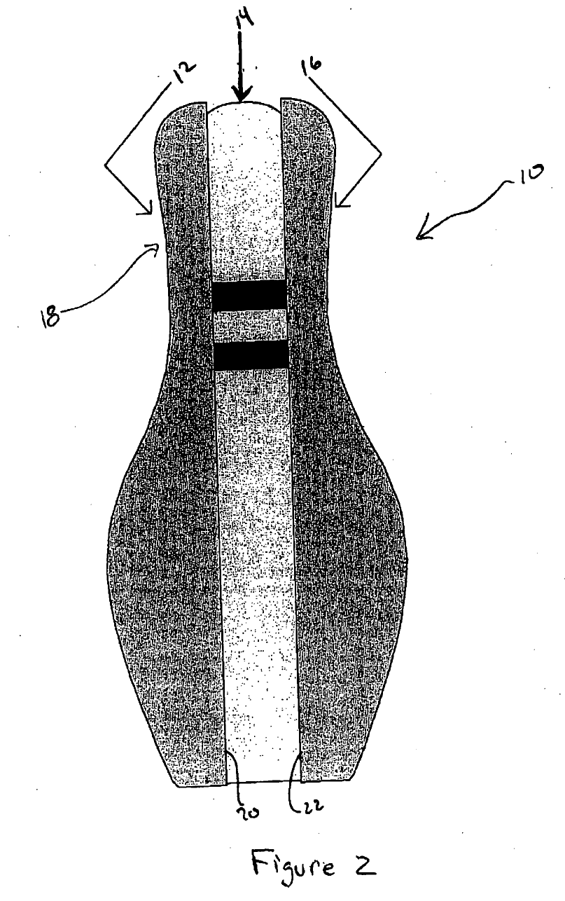

With reference to FIG. 2, a side view of a bowling pin cover 10, in accordance with the present invention is shown and includes a first portion of the cover 12 and a second portion of the cover 16 partially encompassing a bowling pin 14. The first portion of the cover 12 and the second portion of the cover 16 have the general shape of a bowling pin with a portion of greater diameter in the lower area of the first portion of the cover 12 and the second portion of the cover 16. The bowling pin cover 10 has an upper portion, which is of a lesser diameter and a rounded end 18. The first portion of the cover 12 and the second portion of the cover 16 are abutted at the first cover parameter 20 and the second cover parameter 22 to form a cavity along the longitudinal axis in the general shape of a bowling pin.

The first cover parameter 20 and the second cover parameter 22 may take a variety of profiles when abutted. For example, the first cover parameter 20 has a notch (not shown) and the second cover parameter 22 has a groove (not shown), wherein the notch (not shown) and groove (not shown) fit together to secure the first portion of the cover 12 and a second portion of the cover 16. The first cover parameter 20 may have a variety of profiles, which mate to the corresponding counter profile on the second cover parameter 22. The profiles may be slots and notches, holes and pegs, curves and curves, whole and peg or a combination thereof. In addition, the profiles (not shown) may have structures that secure the first portion of the cover 12 and the second portion of the cover 16, e.g., pins, gaskets or rivets. In some instances, the profiles (not shown) overlap to secure the first portion of the cover 12 and the second portion of the cover 16. In addition, the first cover parameter 20 and the second cover parameter 22 may be secured with a solvent, epoxy, adhesive, molded together, melted together or combination thereof.

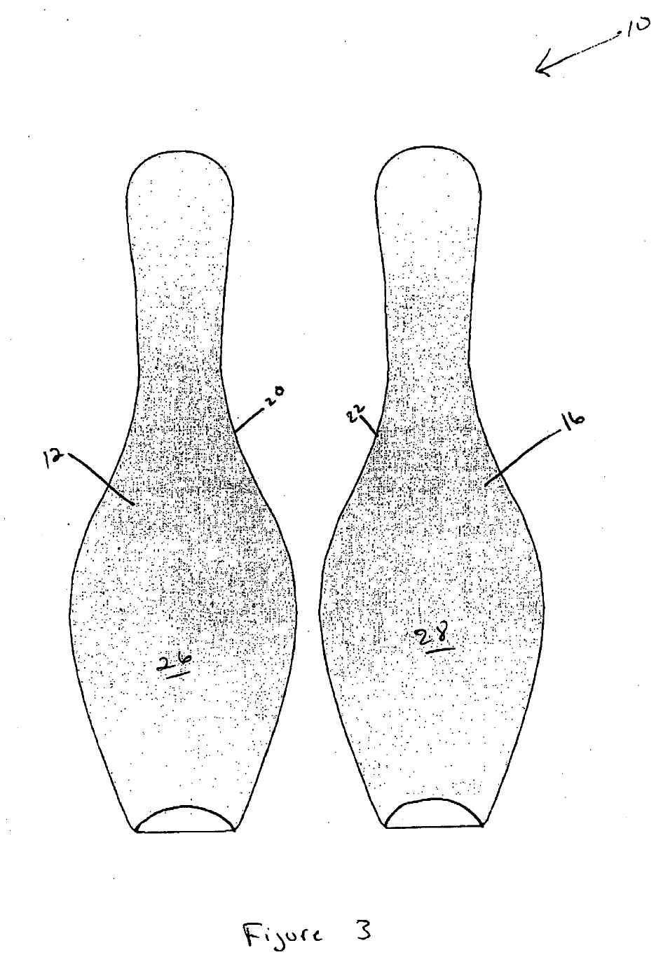

With reference to FIG. 3, a front view of the bowling pin cover 10, in accordance with the present invention, is shown and includes a first portion of the cover 12 and a second portion of the cover 16. The first portion of the cover 12 and the second portion of the cover 16 have the general shape of a bowling pin with a portion of greater diameter in the lower region of the first portion of the cover 12 and the second portion of the cover 16. The bowling pin cover 10 has an upper portion, which is of a lesser diameter and a rounded end 18. The first portion of the cover 12 has a first cavity 26 and the second portion of the cover 16 has a second cavity 28 that are abutted at the first cover parameter 20 and the second cover parameter 22 to form a cavity (not shown) along the longitudinal axis in the general shape of a bowling pin.

The first cover parameter 20 and the second cover parameter 22 may take a variety of profiles to produce a junction. The first cover parameter 20 has a notch (not shown) and the second cover parameter 22 has a groove (not shown), wherein the notch (not shown) and groove (not shown) fit together to secure the first portion of the cover 12 and a second portion of the cover 16. The first cover parameter 20 may have a variety of profiles, which mate to the corresponding counter profile on the second cover parameter 22. The profiles may be slots and notches, holes and pegs, curves and curves, whole and peg or a combination thereof. In addition, the profiles (not shown) may have structures that secure the first portion of the cover 12 and the second portion of the cover 16. In some instances, the profiles (not shown) overlap to secure the first portion of the cover 12 and the second portion of the cover 16. In addition, the first cover parameter 20 and the second cover parameter 22 may be secured with a solvent, epoxy, adhesive, molded together, melted together or combination thereof.

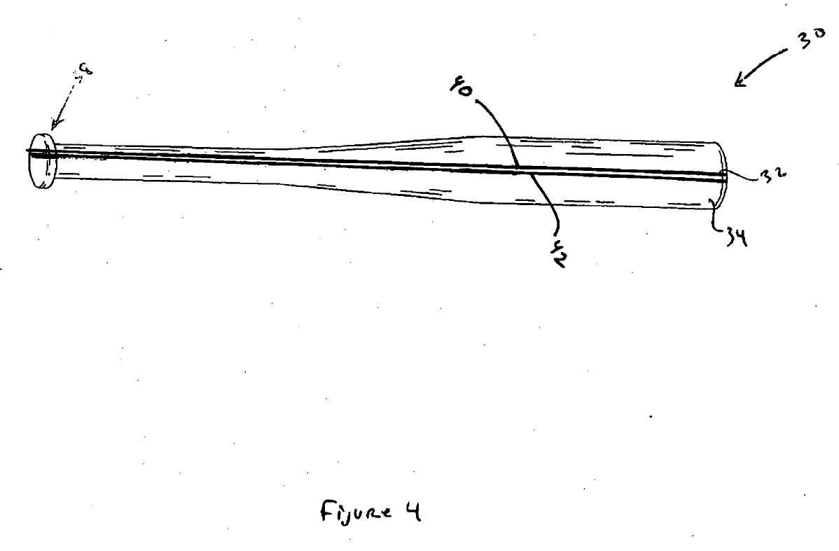

With reference to FIG. 4, a side view of a baseball bat cover 30, in accordance with the present invention, is shown and includes a first portion of the cover 32 and a second portion of the cover 36. The first portion of the cover 32 and the second portion of the cover 36 have the general shape of a baseball bat with a portion of greater diameter in the lower region of the first portion of the cover 32 and the second portion of the cover 36. The baseball bat cover 30 has a lower portion, which is of a lesser diameter 38. The first portion of the cover 32 and the second portion of the cover 36 are abutted at the first cover parameter 40 and the second cover parameter 42 to form a cavity along the horizontal axis in the general shape of a baseball bat.

The first cover parameter 40 and the second cover parameter 42 may take a variety of forms to produce a junction. The first cover parameter 40 has a notch (not shown) and the second cover parameter 42 has a groove (not shown), wherein the notch (not shown) and groove (not shown) fit together to secure the first portion of the cover 32 and a second portion of the cover 36. The first cover parameter 40 may have a variety of profiles, which mate to the corresponding counter profile on the second cover parameter 42, e.g., the profiles may be slots and notches, holes and pegs, curves and curves, whole and peg or a combination thereof. In addition, the profiles (not shown) may have structures that secure the first portion of the cover 32 and the second portion of the cover 36. In some instances, the profiles (not shown) overlap to secure the first portion of the cover 32 and the second portion of the cover 36. In addition, the first cover parameter 40 and the second cover parameter 42 may be secured with a solvent, epoxy, adhesive, molded together, melted together or combination thereof.

The baseball bat cover 30 may be constructed from a variety of materials including metals, plastics wood, polymers, plasters, composites, ceramics, granite, stone, wicker, bamboo, clay, brick and mixtures and combinations thereof. In addition, the baseball bat cover 30 may be constructed of different materials in different regions. Furthermore, the baseball bat cover 30 may be stained, engraved, painted, varnished, etched, coated, glazed, fused, impregnated and combinations thereof. In particular, the baseball bat cover 30 may be coated with a substance to accommodate decorations, e.g., decoupaged, painted and signed.

For example, a baseball bat (not shown) is given as a gift; however, the baseball bat is dented, scratched and generally unsightly. The baseball bat (not shown) is placed into the baseball bat cover 30 and the first portion of the cover 32 and second portion of the cover 36 are abutted at the first cover parameter 40 and second cover parameter 42 to secure the baseball bat cover 30. The baseball bat cover 30 is then decorated, signed and colored to immortalize the party and the baseball player.

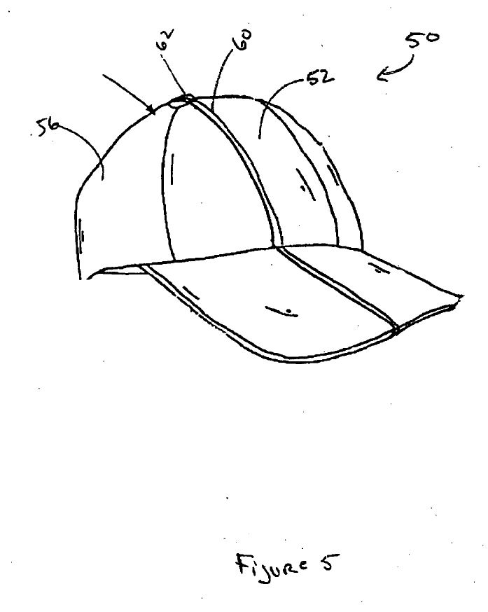

With reference to FIG. 5 illustrates a side view of a hat cover 50 in accordance with the present invention. The hat cover 50 includes a first portion of the cover 52 and a second portion of the cover 54. The first portion of the cover 52 and the second portion of the cover 54 have the general shape of a hat. The first portion of the cover 52 and the second portion of the cover 54 are abutted at the first cover parameter 50 and the second cover parameter 52 to form a cavity along the longitudinal axis in the general shape of a hat (not shown).

The first cover parameter 56 and the second cover parameter 58 may take a variety of forms to produce a junction. The first cover parameter 56 has a notch (not shown) and the second cover parameter 58 has a groove (not shown), wherein the notch (not shown) and groove (not shown) fit together to secure the first portion of the cover 52 and a second portion of the cover 54. The first cover parameter 56 may have a variety of profiles, which mate to the corresponding counter profile on the second cover parameter 58. The profiles may be slots and notches, holes and pegs, curves and curves, whole and peg or a combination thereof. In addition, the profiles (not shown) may have structures that secure the first portion of the cover 52 and the second portion of the hat cover 54. In some instances, the profiles (not shown) overlap to secure the first portion of the cover 52 and the second portion of the cover 16. In addition, the first cover parameter 56 and the second cover parameter 58 may be secured with a solvent, epoxy, adhesive, molded together, melted together. or combination thereof.

The hat cover 50 maybe constructed from a variety of materials including metals, plastics wood, polymers, plasters, composites, ceramics, granite, stone, wicker, bamboo, clay, brick and mixtures and combinations thereof. In addition, the hat cover 50 may be constructed of different materials in different regions. Furthermore, the hat cover 50 may be stained, engraved, painted, varnished, etched, coated, glazed, fused, impregnated and combinations thereof. In particular, the hat cover 50 may be coated with a substance to allow the decoration of the hat cover 50, e.g., decoupaged, painted and signed.

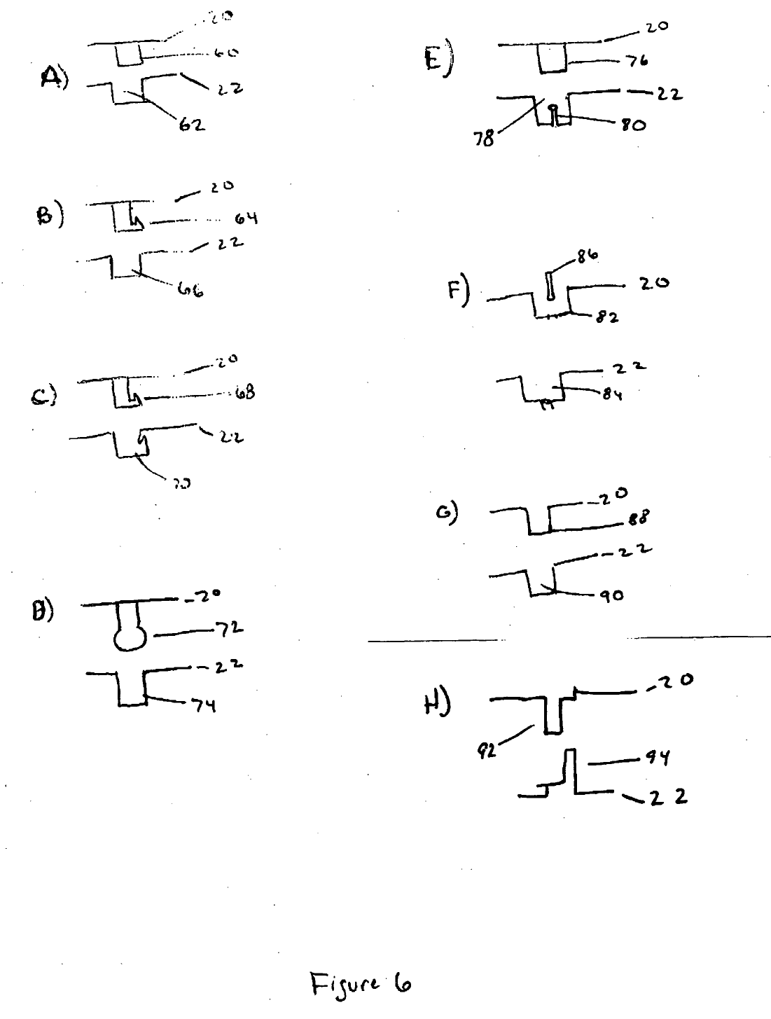

With reference to FIGS. 6A-6H, exemplar illustrations of the profiles used in conjunction with the present invention. FIG. 6A depicts a tongue and groove securing mechanism. The first cover parameter 20 provides a first profile having a tongue 60, which mates to a second profile having a groove 62 in the second cover parameter 22. The groove 62 has a flexible tab positioned therein to increase the friction applied to the tongue 60 and groove 62 to holding the first cover parameter 20 and the second cover parameter 22.

FIG. 6B depicts another tongue and groove securing mechanism. The first cover parameter 20 provides a first profile having a tongue 64, which mates to a second profile having a groove 66 in the second cover parameter 22. The tongue 64 has a flexible tab positioned thereon to increase the friction applied to the groove 66 to holding the first cover parameter 20 and the second cover parameter 22.

FIG. 6C depicts yet another tongue and groove securing mechanism. The first cover parameter 20 provides a first profile having a tongue 68, which mates to a second profile having a groove 70 in the second cover parameter 22. Both the tongue 68 and the groove 70 have flexible tabs positioned therein to increase the friction holding the first cover parameter 20 and the second cover parameter 22. In addition to increasing the friction, the flexible tabs on the tongue 68 and groove 70 interact to secure the first cover parameter 20 and the second cover parameter 22.

FIG. 6D depicts a tongue and groove securing mechanism. The first cover parameter 20 provides a first profile having a tongue 72 with an enlarged end that mates to a second profile having a groove 74 in the second cover parameter 22. The groove 74 has a diameter that is smaller than the tongue 72, thereby increasing the friction holding the first cover parameter 20 and the second cover parameter 22.

FIG. 6E depicts a securing mechanism. The first cover parameter 20 provides a first profile having a tongue 76, which mates to a groove 78 in the second cover parameter 22. The groove 78 has a pin 80 extending outwardly, which penetrates the tongue 76 to secure the first cover parameter 20 to the second cover. parameter 22.

FIG. 6F depicts a pin securing mechanism. The first cover parameter 20 provides a first profile having a notch 82, which mates to a second profile having a groove 84 in the second cover parameter 22. A pin 86 penetrates the notch 82 and the groove 84 to secure the first cover parameter 20 to the second cover parameter 22.

FIG. 6G depicts a notch and valley securing mechanism. The first cover parameter 20 provides a first profile having a notch 88, which mates to a second profile having a valley 90 in the second cover parameter 22. The valley 90 can be affixed to the notch 88 to secure the first cover parameter 20 and the second cover parameter 22. Generally, the valley 90 and the notch 88 are glued together; however, the skilled artisan will recognize that other affixing methods are equally effective, e.g., welding, solder, glue, epoxy, fasteners and the like. In addition, the valley 90 may have a cross section that is square, rectangular, triangular, semicircular, polygonal or combinations thereof.

FIG. 6H depicts tab securing mechanism. The first cover parameter 20 provides a first profile having a tongue 92, which mates to a second profile having a second tongue 94 on the second cover parameter 22. The mating of the tongue 92 and the tongue 94 causes friction to secure the first cover parameter 20 and the second cover parameter 22 together. Alternatively, the tongue 92, the tongue 94 or both the tongue 92 and the tongue 94 may have flexible tabs positioned to increase the friction holding the first cover parameter 20 and the second cover parameter 22.

In the claims, all transitional phrases such as “comprising,” “including,” “carrying,” “having,” “containing,” “involving,” and the like are to be understood to be open-ended, i.e., to mean including but not limited to. Only the transitional phrases “consisting of” and “consisting essentially of,” respectively, shall be closed or semi-closed transitional phrases.

It is contemplated that any embodiment discussed in this specification can be implemented with respect to any method, kit, reagent, or composition of the invention, and vice versa. Furthermore, compositions of the invention can be used to achieve methods of the invention.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific procedures described herein. Such equivalents are considered to be within the scope of this invention and are covered by the claims.

All publications and patent applications mentioned in the specification are indicative of the level of skill of those skilled in the art to which this invention pertains. All publications and patent applications are herein incorporated by reference to the same extent as if each individual publication or patent application was specifically and individually indicated to be incorporated by reference.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, MB, BBC, AAABCCCC, CBBAAA, CABABB, and so forth. The skilled artisan will understand that typically there is no limit on the number of items or terms in any combination, unless otherwise apparent from the context.

All of the compositions and/or methods disclosed and claimed herein can be made and executed without undue experimentation in light of the present disclosure. While the compositions and methods of this invention have been described in terms of preferred embodiments, it will be apparent to those of skill in the art that variations may be applied to the compositions and/or methods and in the steps or in the sequence of steps of the method described herein without departing from the concept, spirit and scope of the invention. All such similar substitutes and modifications apparent to those skilled in the art are deemed to be within the spirit, scope and concept of the invention as defined by the appended claims.

What is claimed is:

1. A memorabilia cover comprising:
a first portion of the cover comprising a first cavity along a longitudinal axis abutted to a second portion of the cover comprising a second cavity along the longitudinal axis, wherein the aligning of the first portion and second portion form a cover having a cavity with the general dimensions of the memorabilia item.

2. The cover of claim 1, wherein the memorabilia item comprises a bowling pin, a bat, a hat, a baseball, a football, a soccer ball, a golf club, a hockey puck, a hockey stick, a boxing glove, a basketball, a bottle or combinations thereof.

3. The cover of claim 1, wherein the first portion of the cover and the second portion of the cover interlock.

4. The cover of claim 1, wherein the first portion of the cover comprise a ridge, which abuts to a groove on the second portion of the cover.

5. The cover of claim 1, wherein the first portion of the cover and the second portion of the cover form a seal.

6. The cover of claim 1, wherein the first portion of the cover, the second portion of the cover or both the first portion of the cover and the second portion of the cover comprise a plastic, a polymer, a metal, a composite, wood, stone, marble, carbon fiber, plaster or combinations thereof.

7. The cover of claim 1, wherein one or more portions of the first portion of the cover, the second portion of the cover or both the first portion of the cover and the second portion of the cover are transparent, opaque, florescent, painted, coated, stained, etched, embossed, pitted, engraved or combinations thereof.

8. The cover of claim 1, wherein at least a portion of the cover is decoratable.

9. The cover of claim 1, further comprising a peelable protective sheet adhered removably on the memorabilia cover.

10. A method for covering a memorabilia item comprising the steps of:
placing a memorabilia item into a first side cover having a first cavity along an axis; and
abutting a second side cover having a second cavity along an axis, wherein the abutting of the first side cover and second side cover form a cavity comprising the general dimensions of the memorabilia item.

11. The method of claim 10, wherein the first side cover and the second side cover interlock.

12. The method of claim 10, wherein the first side cover, the second side cover or both the first side cover and the second side cover comprise a plastic, a polymer, a metal, a composite, wood, stone, marble, carbon fiber, plaster or combinations thereof.

13. The method of claim 10, wherein the first side cover, the second side cover or both the first side cover and the second side cover comprise one or more regions that are transparent, opaque, florescent, painted, coated, stained, etched, embossed, pitted, engraved or combinations thereof.

14. A bowling pin covering kit comprising:
a first portion of the cover having a first cavity abutted to a second portion of the cover having a second cavity, wherein the aligning of the first portion of the cover and second portion of the cover form a cavity having the general dimensions of the bowling pin.

15. The kit of claim 14, wherein the first portion of the cover comprise a ridge, which abuts to a groove on the second portion of the cover.

16. The kit of claim 14, wherein the first portion of the cover and the second portion of the cover form a seal.

17. The kit of claim 14, wherein the first portion of the cover, the second portion of the cover or both the first portion of the cover and the second portion of the cover comprise a plastic, a polymer, a metal, a composite, wood, stone, marble, carbon fiber, plaster or combinations thereof.

18. The kit of claim 14, wherein one or more portions of the first portion of the cover, the second portion of the cover or both the first portion of the cover and the second portion of the cover are transparent, opaque, florescent, painted, coated, stained, etched, embossed, pitted, engraved or combinations thereof.

19. The kit of claim 14, wherein at least a portion of the cover is decoratable.

20. The kit of claim 14, further comprising a peelable protective sheet removably adhered on the memorabilia cover.
